(19) United States
(12) Patent Application Publication
(10) Pub. No.: US 2021/0266288 A1
(43) Pub. Date: Aug. 26, 2021

(54) DEVICES AND METHODS FOR OPERATING A POWER DISTRIBUTION GATEWAY

(71) Applicant: Eaton Intelligent Power Limited, Dublin (IE)

(72) Inventors: Praveen Sutrave, Moon, PA (US); Ashwin Kashinath Patwekar, Pune (IN)

(21) Appl. No.: 17/154,163

(22) Filed: Jan. 21, 2021

Related U.S. Application Data
(60) Provisional application No. 62/979,976, filed on Feb. 21, 2020.

(51) Int. Cl. H04L 29/06; H04L 12/66; H04L 12/10; H04L 29/08

(52) U.S. Cl. CPC H04L 63/02; H04L 12/66; H04L 63/10; H04L 67/1097; H04L 63/1425; H04L 12/10

(57) ABSTRACT

A power distribution gateway that is configured to be coupled to one or more devices in a power system network is described. The power distribution gateway includes a processor, a docker and a container manager that are configured to execute on the processor independently of one another, a first container associated with the container manager that interfaces with the one or more devices in the power system network, and a power distribution gateway application. When the power distribution gateway application is executed, the processor is configured to perform operations including receiving information from the one or more devices in the power system network, and storing the information in a core data storage in the power distribution gateway and/or in a cloud data storage that is remote from the power distribution gateway, and blocking access from a second container to a host OS of the power distribution gateway.

### RELATED APPLICATIONS

This application claims the benefit of and priority to U.S. Provisional Patent Application Ser. No. 62/979,976, filed Feb. 21, 2020, the contents of which are hereby incorporated by reference as if recited in full herein.

### FIELD

Various embodiments described herein relate to devices and methods for a power distribution gateway and more particularly to data acquisition by a power distribution gateway.

### BACKGROUND

Conventional gateways traditionally implement firmware to connect devices to a network and perform conversion of various protocols used by the conventional gateway. Development of a conventional gateway may be a time-consuming endeavor that includes customization of firmware, kernels, device drivers and other modules. Compatibility and maintainability of conventional gateways may be difficult as customer needs, libraries, and application software are modified or updated.

### SUMMARY

Various embodiments of the present invention are directed to a power distribution gateway that is configured to be coupled to one or more devices in a power system network. The power distribution gateway includes a processor, and a docker and a container manager that are configured to execute on the processor independently of one another, and a first container associated with the container manager that is configured to execute on the processor and interface with the one or more devices in the power system network. When the container is executed, the processor is configured to perform operations including receiving, through a network interface, information from the one or more devices in the power system network, and storing the information in a core data storage in the power distribution gateway and/or in a cloud data storage that is remote from the power distribution gateway. The container manager and the power distribution gateway application block access from a second container associated with the docker to a host operating system (OS) of the power distribution gateway.

According to some embodiments, the power distribution gateway may include a power distribution gateway application that executes in the container. The container manager and the power distribution gateway application may create a firewall that blocks access to a host operating system (OS) of the power distribution gateway. The power distribution gateway may include a container manager daemon that is configured to run on the host OS. The container manager daemon may communicate with the power distribution gateway application of the container. The power distribution gateway may include a module in the power distribution gateway application that is configured to communicate with the container manager daemon. The module may receive control commands through the network interface from a cloud that is remote to the power distribution gateway. The control commands that are received may be executed in the container or passed to the container manager daemon. The power distribution gateway may poll the one or more devices in the power system network for the information. The information may include parameters related to operation of the one or more devices in the power system network.

Various embodiments of the present invention are directed to a power distribution gateway that is configured to be coupled to one or more devices in a power system network. The power distribution gateway includes a processor, a docker that is configured to execute on the processor and provide a software platform for the power distribution gateway, and a container that is configured to execute on the processor and interface with the one or more devices in the power system network. When the container is executed, the processor is configured to perform operations including receiving information from the one or more devices in the power system network, storing the information in a core data storage in the power distribution gateway and/or in a cloud data storage that is remote from the power distribution gateway, and controlling operations of the one or more devices based on the information from the one or more devices.

According to some embodiments, the container includes a gateway application container. The power distribution gateway may include an analytics container that includes an Internet of things (IoT) circuit, an interface circuit, and an anomaly detection circuit. The IoT circuit may manage the one or more devices in the power system network. The interface circuit may communicate with the one or more devices in the power system network. The anomaly detection circuit may analyze characteristics of the information received from the one or more devices in the power system network. The anomaly detection circuit may provide an indication of anomalies in voltage, current, and/or power characteristics associated with the one or more devices in the power system network. The container may be agnostic to the hardware of the power distribution gateway, and the hardware may include the processor.

Various embodiments of the present invention are directed to a method of operating a power distribution gateway that is coupled to one or more devices in a power system network. The method includes executing, on a processor of a host in the power distribution gateway, a docker and a container manager. The method includes executing a container that communicates with the one or more devices in the power system network. The method includes receiving, through a network interface, information from the one or more devices in the power system network, storing the information in a core data storage in the power distribution gateway and/or in a cloud data storage that is remote from the power distribution gateway, and blocking access from a second container associated with the docker to a host operating system (OS) of the power distribution gateway.

According to various embodiments, the method may include executing a power distribution gateway application in the container, and creating, by the container manager and the power distribution gateway application, a firewall that blocks access to a host OS of the power distribution gateway. The method may include running a container manager daemon on the host OS. The container manager daemon may communicate with the power distribution gateway application of the container. The method may include communicating, by the power distribution gateway application, with the container manager daemon. The method may include receiving control commands through the network interface from a cloud that is remote to the power distribution gateway. The method may include polling, by the power distribution gateway, for the information from the one or more devices in the power system network. The information may include parameters related to operation of the one or more devices in the power system network. The method may include analyzing characteristics of the information received from the one or more devices in the power system network. The method may include providing an indication of anomalies in voltage, current, and/or power characteristics of the information associated with the one or more devices in the power system network.

Further features, advantages and details of the present invention will be appreciated by those of ordinary skill in the art from a reading of the figures and the detailed description of the preferred embodiments that follow, such description being merely illustrative of the present invention.

It is noted that aspects of the inventive concepts described with respect to one embodiment, may be incorporated in a different embodiment although not specifically described relative thereto. That is, all embodiments and/or features of any embodiment can be combined in any way and/or combination. Other operations according to any of the embodiments described herein may also be performed. These and other aspects of the inventive concepts are described in detail in the specification set forth below.

### BRIEF DESCRIPTION OF THE DRAWINGS

FIG. 1 illustrates a legacy gateway architecture.

FIG. 2 is a block diagram of a power distribution system, according to various embodiments described herein.

FIG. 3 is block diagram of a platform for a power distribution gateway, according to various embodiments described herein.

FIGS. 4, 5, 6 and 9 are block diagrams of a power distribution gateway that may be included in the power distribution system of FIG. 2, according to various embodiments described herein.

FIG. 7 is a flowchart of operations to indicate a startup sequence of a power distribution gateway, according to various embodiments described herein.

FIG. 8 illustrates the architecture of power system gateway of FIGS. 2 to 6, according to various embodiments described herein.

FIGS. 10 to 16 are flowcharts of operations of the power distribution gateway of FIGS. 2, 3 4, 5, 6, 8, and/or 9, according to various embodiments described herein.

### DETAILED DESCRIPTION

Various embodiments will be described more fully hereinafter with reference to the accompanying drawings. Other embodiments may take many different forms and should not be construed as limited to the embodiments set forth herein. Like numbers refer to like elements throughout.

In the drawings, the relative positions, connections, or features may be exaggerated for clarity. This invention may, however, be embodied in many different forms and should not be construed as limited to the embodiments set forth herein. Rather, these embodiments are provided so that this disclosure will be thorough and complete, and will fully convey the scope of the invention to those skilled in the art.

A power distribution gateway may include a processor circuit of a general purpose computer circuit, special purpose computer circuit, and/or other programmable data processing circuit, one or more central processing units (CPU), general purpose units (GPU), and/or microprocessors. As used herein, the term “processor” may refer to one or more processors, CPUs, GPUs, and/or microprocessors. A processor in a power distribution gateway may provide a basis for a platform or host for the power distribution gateway. To implement various functionalities of the host to support applications of the power distribution gateway, an operating system that includes a kernel, device drivers, libraries, system daemons, and other circuits or modules may need to be developed. These various elements may be time-consuming to develop and maintain as changes are implemented in the hardware and/or operating system of the host.

Various embodiments described herein may arise from recognition that isolation of applications from the host and/or host operating system may provide significant cost and time savings during development and maintenance of the power distribution gateway. Rapid deployment, compatibility, maintainability, continuous deployment, and testing of multi-cloud platforms may be realized by providing isolation of applications from the host and/or host operating system using a docker architecture with containers, as will be discussed with respect to various embodiments described herein.

A docker may automate the deployment of software applications inside containers by providing an additional layer of abstractions and automation of operating system (OS)-level virtualization. A docker is a tool that allows developers, system administrations, clients, etc. to easily deploy their applications in containers to run on the host operating system. An important benefit of a docker is that it may allow users to package an application with all of its dependencies into a standardized unit for software development. A docker is a set of platform as a service (PaaS) products that use OS-level virtualization to deliver software in packages called containers. Containers may be isolated from one another and bundle their own software, libraries and configuration files. Containers may communicate with other containers through well-defined channels. Although the inventive concepts will be discussed in the context of a docker architecture, the inventive concepts described herein may be applied to other similar architectures such as the Linux container architecture, LXC. LXC is an operating-system-level virtualization method for running multiple isolated Linux systems on a control host using a single Linux kernel.

Previously, virtual machines have been used to run software applications. Virtual machines are beneficial in providing full process isolation for applications. However, the isolation provided by virtual machines is generally realized by a substantial cost of the computational overhead spent virtualizing hardware. Containers take a different approach by leveraging the low-level mechanics of the host operating system. Containers may provide most of the isolation of virtual machines at a fraction of the computing power. In other words, unlike virtual machines, containers do not have high overhead and hence may enable more efficient usage of the underlying system and resources.

A container is a standard unit of software that packages code and all its dependencies so that the application runs quickly and reliably from one computing environment to another. A docker container image is usually a lightweight, standalone, executable package of software that includes everything that may be needed to run an application, such as code, runtime, system tools, system libraries and settings. Container images become containers at runtime. Containers are typically run by a single operating-system kernel and are thus more lightweight than virtual machines. In the case of docker containers, images become containers when they run on a docker engine. Containerized software will run in the same manner, regardless of the infrastructure. The containers isolate software from its environment and ensure that it works uniformly despite differences between development and staging.

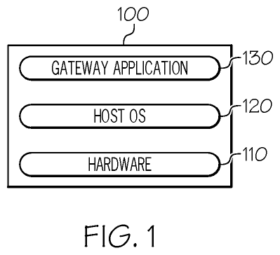

FIG. 1 illustrates a legacy gateway architecture. Referring to FIG. 1, a legacy gateway 100 may include hardware 110, a host operating system 120, and a gateway application 130 that runs on the host operating system 120. If modifications or updates are made to the host operating system 120, corresponding changes to the gateway application 130 may be needed. Additionally, development of the gateway application 130 may rely on knowledge of the host operating system 120. Therefore, development and maintenance of the legacy gateway 100 may be time consuming and expensive due to the tight coupling between the hardware 110, host operating system 120, and the gateway application 130.

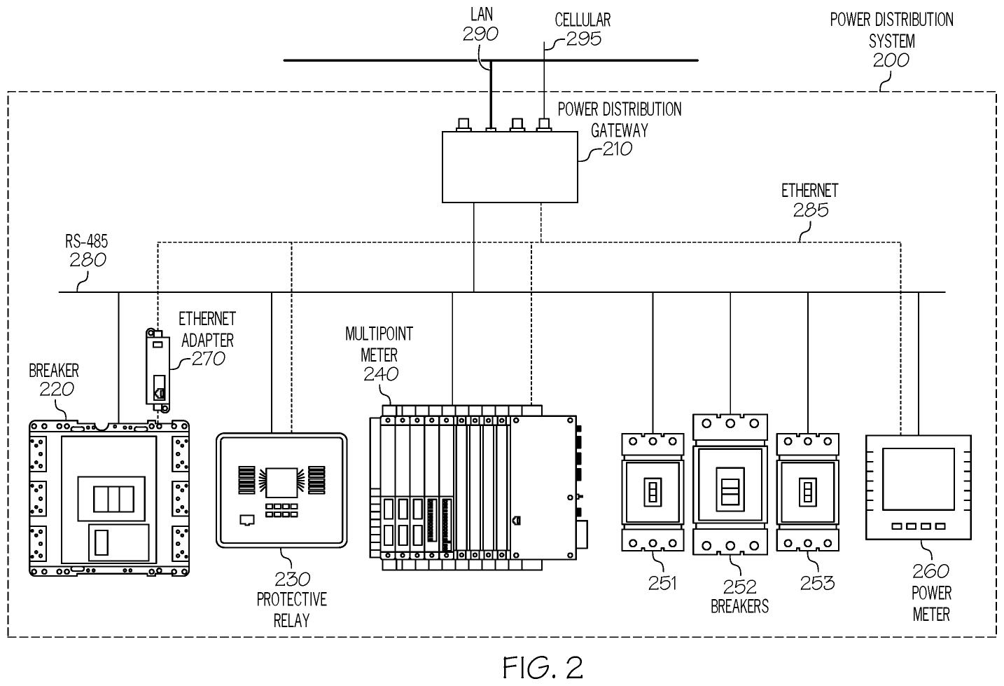

FIG. 2 is a block diagram of a power distribution system, according to various embodiments described herein. Referring to FIG. 2, a power distribution system 200 may include a power distribution gateway 210 that has a LAN interface 290 and/or a cellular interface 295. The power distribution gateway 210 may be connected to one or more devices of the power distribution system 200 by various network connections that use different protocols over an Ethernet interface 285 and/or an RS-485 interface 280. These may be wired or wireless interfaces. The power distribution system 200 may include features permitting attachment of fuses, relays, switches, wires, circuit breakers, and other electrical devices. The devices of the power distribution system 200 may include, for example, a circuit breaker 220, protective relay 230, a multipoint meter 240, breakers 251, 252, 253, and/or a power meter 260. In some embodiments, the power distribution gateway 210 may be connected by the RS-485 interface 280 to Ethernet adapter 270, which is connected to the circuit breaker 220. Power meter 260 may measure various electrical characteristics such as, for example, power, current, voltage, and/or power quality to identify spikes in the power circuit. Circuit breaker 220, also referred to as a “breaker” may be one of a variety of overcurrent protection devices used for circuit protection and isolation. The circuit breaker 220 provides electrical protection whenever an electrical abnormality occurs. In a typical circuit breaker 220, current enters the system from a power line and passes through a line conductor to a breaker that is attached to a device that is protected by the circuit breaker 220. In other words, circuit breaker 220 protects a down-stream electrical device that is connected to the circuit breaker 220. The circuit breaker 220 may connect to a branch of a building that includes devices such as servers, HVAC equipment, etc. An electrical distribution panel may include a primary breaker 252 that is electrically connected to one or more auxiliary breakers 251, 253. A building management system may provide control and performance characteristics of power distribution system 200. A building management system may use the power distribution gateway 210 to tie all devices in the building to a single building management system.

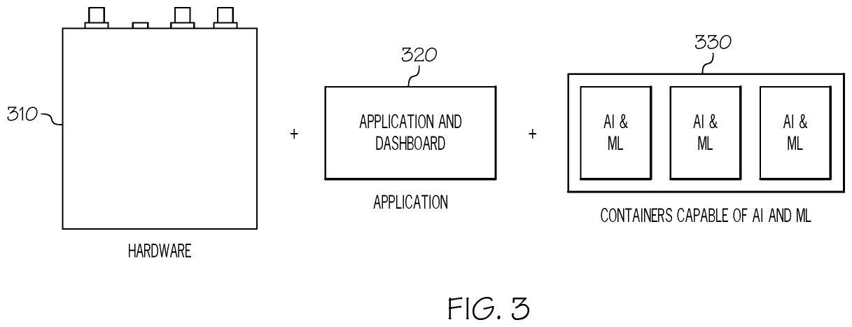

FIG. 3 is block diagram of a platform for a power distribution gateway, according to various embodiments described herein. Referring to FIG. 3, the power distribution gateway 210 of FIG. 2 may include hardware 310 such as one or more processors, an application and/or dashboard 320 that runs on the hardware 310, and containers 330 that implement artificial intelligence (AI) and/or machine learning (ML) functionality. The AI and/or ML containers may include, for example, intelligent power applications, web services applications, and/or social media applications. The hardware 310 may have a host operating system on which applications may run. Containers 330 may provide the ability to perform data processing at the edge (i.e. in the power distribution gateway 210) instead of in the cloud, according to some embodiments. Performing data processing locally in the power distribution gateway 210 may improve performance by performing computationally intense analytics locally instead of remotely and/or in the cloud.

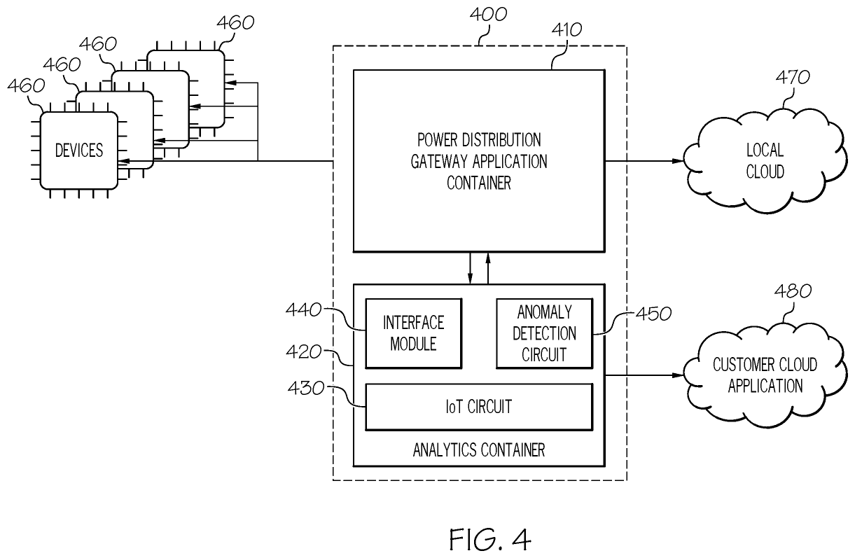

FIG. 4 is a block diagram of a power distribution gateway that may be included in the power distribution system of FIG. 2, according to various embodiments described herein. FIG. 4 provides an example of edge applications running in the power distribution gateway 210 of FIG. 2. Referring to FIG. 4, power distribution gateway 400 includes a power gateway application container 410 and an analytics container 420. The power distribution gateway 400 connects to various electronic devices 460 of the power distribution system 200 such as meters, protective relays, circuit breakers, etc. The power gateway application container 410 collects data, archives data, and/or pushes the data to the local cloud 470. The local cloud 470 may be a network that is accessible by, but remote from the power distribution gateway 400. The local cloud 470 may be part of or co-located with the power distribution system 200 of FIG. 2. Historical data may be moved from a core data storage in the power distribution gateway 400 to the local cloud 470. The power gateway application container 410 may maintain a database of data coming from various electronic devices 460. The analytics container 420 may include an interface module 440, an anomaly detection circuit 450, and an IoT circuit 430. The power distribution gateway 400 may be connected to various electronic devices 460 through an interface such as a Modbus TCP/RTU interface. Interface module 440 may be, for example, a Modbus module with a REST interface. A protocol such as Modbus may be used by the power distribution gateway 400 to poll data from the electronic devices 460 that are connected to the power distribution gateway 400. The power gateway application container 410 may communicate with a local cloud 470 to store information from the electronic devices 460. In some embodiments, the power distribution gateway 400 may communicate with the local cloud 470 by a Wi-Fi or cellular connection to push data to the local cloud 470.

The analytics container 420 may be connected to a customer cloud application 480 to store customer specific information about one or more of the electronic devices 460. The customer cloud application 480 in a customer cloud may be remote from the power distribution gateway 400 and/or from the power distribution system 200 of FIG. 2. The local cloud 470 and the customer cloud application 480 in the customer cloud may be separated and not accessible to one another. Anomaly detection circuit 450 may compile and/or aggregate data from electronic devices 460 and perform analysis in order to determine anomalies in the power distribution system. IoT circuit 430 may interface with electronic devices 460 and or with the customer cloud application 480. IoT circuit 430 may be responsible for updating workloads on a device, maintaining security standards, reporting health for the customer cloud application 480, and/or managing communication between downstream devices, IoT edge devices, and the cloud. Customers may develop a custom analytics container 420 and/or portions thereof and deploy or update these from the customer cloud application 480. In some embodiments, an automatic deployment of the analytics container 420 may occur. The anomaly detection circuit 450 may be configured to analyze characteristics of the information received from the electronic devices 460 in the power system network. The analytics container 420 may be accessible to the customer cloud application 480. However, a firewall may prevent the customer cloud application 480 from accessing some of the data associated with the power gateway application container 410 and/or from accessing the host OS and/or hardware.

In some embodiments, the anomaly detection circuit may provide an alarm and/or indication of anomalies in voltage, current, and/or power characteristics associated with the one or more devices 460 in the power system network. For example, the anomaly detection circuit 450 may provide voltage analytics detection such that if the voltage went above a threshold voltage, an alarm may be sent to the customer cloud application 480. As another example, if a portion of the power distribution system experiences a high demand for energy, the anomaly detection circuit 450 may detect this scenario to facilitate analysis of motors, circuit breakers, HVAC units, etc. to aide in detecting where in the power distribution system there may be an issue causing the higher demand for energy. Thresholds on parameters such as voltage, current, power, etc. or changes over time of these parameters may be used to detect the higher demand and/or problems with one of more of the electronic devices 460 in the power distribution system.

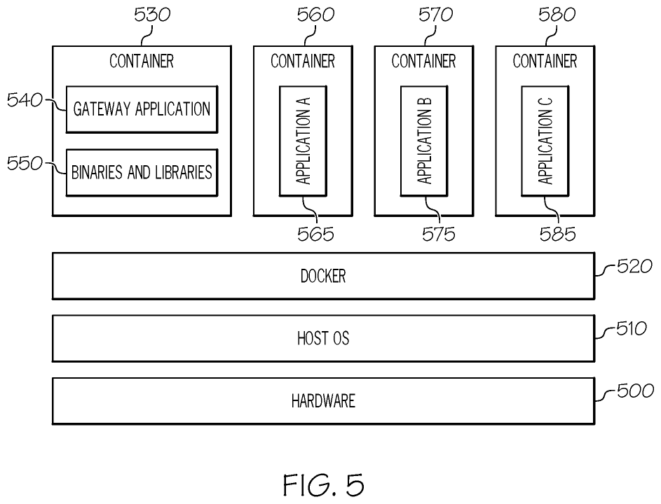

FIG. 5 is a block diagram of a power distribution gateway that may be included in the power distribution system of FIG. 2, according to various embodiments described herein. Referring to FIG. 5, hardware 500 may have a host operating system 510 running on it (i.e., executing by one or more processors of the hardware 500). A docker 520 may be running on the host operating system 510 and provide isolation for containers and/or applications from the hardware 500 and/or the host operating system 510. Containers 530, 560, 570, and/or 580 may be running various applications using the docker 520. For example, container 530 may include a gateway application 540 and binaries and libraries 550. Containers 560, 570, and 580, may run applications 565, 575, and 585, respectively, that access one or more devices such as circuit breaker 220, protective relay 230, multipoint meter 240, breakers 251, 252, 253, and/or power meter 260 of FIG. 2. Each of the containers 560, 570, 580 may be associated with a corresponding one of the devices such as circuit breaker 220, protective relay 230, multipoint meter 240, breakers 251, 252, 253, and/or power meter 260 of FIG. 2.

FIG. 6 is a block diagram of a power distribution gateway that may be included in the power distribution system of FIG. 2, according to various embodiments described herein. Referring to FIG. 6, the host of the power distribution gateway includes hardware 600 that may have a host operating system 610 running on it. A container manager 620 and a docker service of docker 630 may be running on or executing under the control of the host operating system 610. The container manager 620 and the docker 630 may be executing independently of one another. Container 640 may be running a gateway application 650 on the container manager 620. Containers 670, 680, and/or 690, may run applications 675, 685, and 695, respectively, and may run on the docker 630.

In some embodiments, container 640, which includes a gateway application 650 and binaries and libraries 660, may be running on the container manager 620. On the host operating system 610, a container manager daemon associated with container manager 620 may be running. The container manager daemon may communicate with the gateway application 650 on container 640. The container manager 620 and/or the gateway application 650 may setup a firewall to block access to the host operating system 610 by a different container 670, 680, and/or 690 than the container 640 that is associated with the gateway application 650. With the firewall in place, network users and/or customers can access only the services hosted inside container 670, 680, or 690 associated with the particular network user or customer. The gateway application 650 that is inside container 640 includes a module which may communicate with the container manager daemon of the container manager 620 that is running on the host. This module may receive control commands from the cloud and run these either in the container 640 or pass them to the container manager daemon that running on the host. This scheme allows functionalities on the host operating system 610 that are outside of docker 630 (i.e., not executing in the context of docket 630). For example, functionalities outside of docker 630 that are implemented by the gateway application 650 may include installing and/or removing new software on the host operating system 610, starting and/or stopping services on the host (for example, controlling the network interfaces), allowing access to the host for maintenance purposes, installing and/or removing additional docker containers on the host, or controlling other containers by starting, stopping, and/or killing other containers.

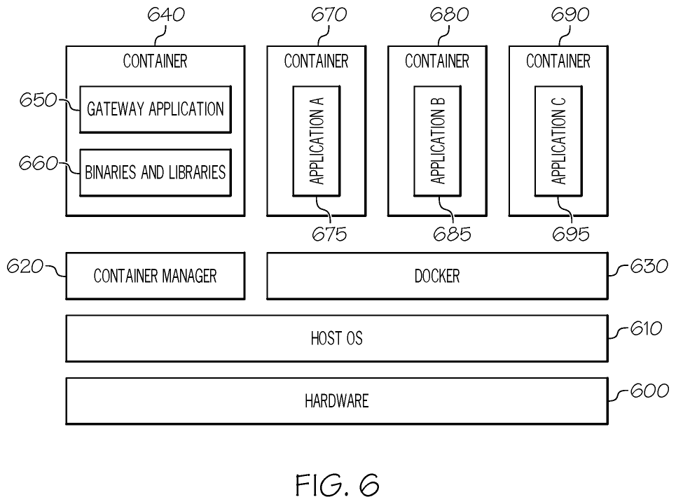

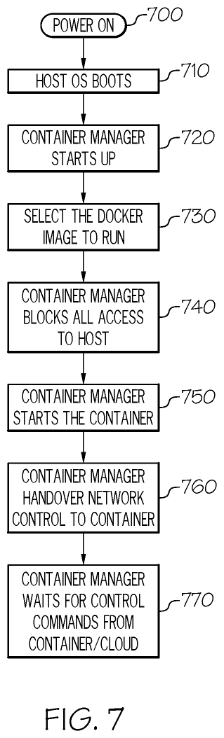

FIG. 7 is a flowchart of operations to indicate a startup sequence of a power distribution gateway, according to various embodiments described herein. The power distribution gateway of FIG. 6, for example, may follow a startup sequence. Referring to FIG. 7, the power distribution gateway may be powered on, at block 700. The host operating system 610 of FIG. 6 may boot, at block 710. The container manager 620 of FIG. 6 may be started, at block 720. During the boot process, the container manager daemon of the container manager 620 of FIG. 6 may start up. After the system initialization is complete, the container manager daemon selects the docker image to start up. The docker image may be selected to run on the host operating system 610 of FIG. 6, at block 730. Before starting the container 640, the container manager 620 may block access to the host for purposes of security, at block 740. Container manager 620 may then start execution of the container 640, at block 750. The container manager 620 may hand over network control to the container 640, at block 760. The container manager 620 may wait for control commands from the container and/or the customer cloud application, at block 770.

FIG. 8 illustrates the architecture of power system gateway of FIGS. 2 to 6 and/or 8, according to various embodiments described herein. Referring to FIG. 8, the power distribution gateway includes host 800 that includes hardware, software, and/or a combination thereof. Hardware 810 may include a processor circuit that includes one or more processors, CPUs, GPUs, and/or microprocessors. Host 800 includes an operating system 820 that includes the kernel, device drivers, and other modules. The host 800 may also include system libraries 830 and system daemons 840. A docker 850 may run on the host 800. Containers 860, 852, 854, and/or 856 that include various applications may execute on the host 800. Container 860 includes a network interface 872 for communicating with various power system devices, operators, and/or customer applications. Container 860 may include mid-level servers 880 such as a notification agent 882 and/or a configuration subscriber 884 that access the core data store API/database 870. The core data storage 870 may be part of the power distribution gateway, whereas storage in local cloud 470 of FIG. 4 may be remote the power distribution gateway. Mid-level servers 880 may use internal subscriptions to get notifications of changes to services and/or values of data in the core data store API/database 870. A callback function may be utilized by the mid-level servers 880 to notify data servers 888.

The network interface 872 may get instructions from the local cloud 470 and/or the customer cloud application 480 of FIG. 4. The network interface 872 may provide communication with data servers 888, an HTTP server 874 and/or an SMTP interface 878. HTTP server 874 may communicate through a gSOAP interface 876 with data servers 888 such as BACnetWS+ server 890 and/or WS publisher agent 891. The SMTP interface 878 may be used to communicate with email agent 892. External devices, external networks, clients, and/or customers may communicate through the network interface 872 with data servers 888 such as SNMP agent 893, UPnP server 894, Modbus TCP Server 895, and/or NTP client server 896. The BACnetWS+ server 890, WS publisher agent 891, email agent 892, SNMP agent 893, UPnP server 894, and/or Modbus TCP Server 895 may access the core data store API/database 870. An IoT agent 890 may communicate directly with the core data store API/database 870. IoT agent 890 may use the network interface 872 to connect to the local cloud 470 of FIG. 4. A pass through mode may be available to bypass the core data store API/database 870 for the Modbus TCP Server 895 to directly access device handlers 868. Device handlers 868, as such a power xpert meter 861, XCP UPS/PDU 862, INCOM 863, QCPort 864, new device 865, and/or Modbus RTU 866 may communicate with the core data store API/database 870.

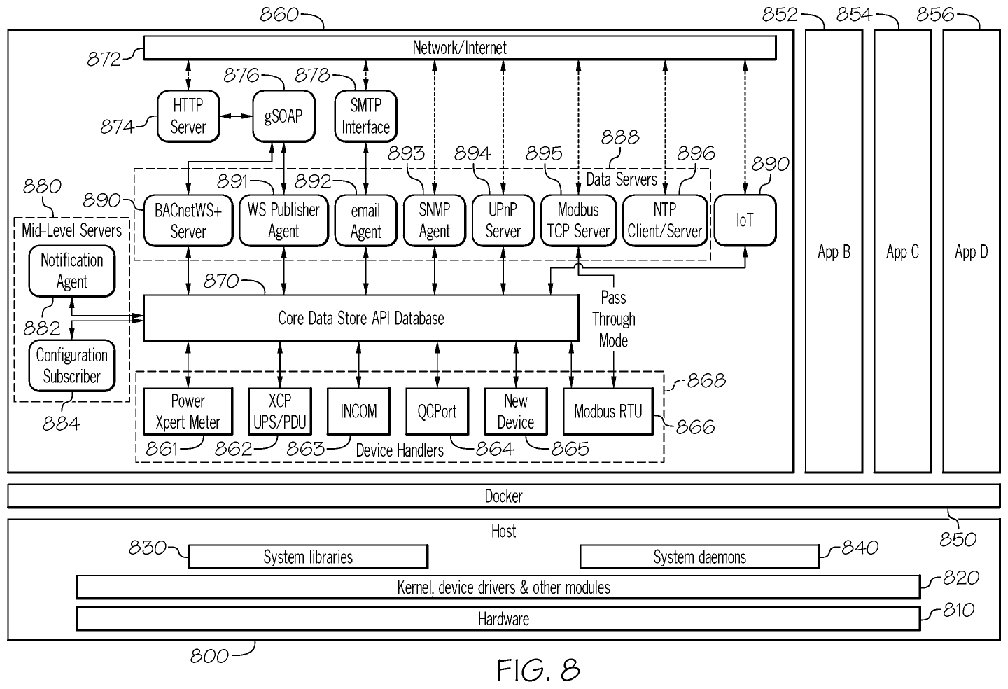

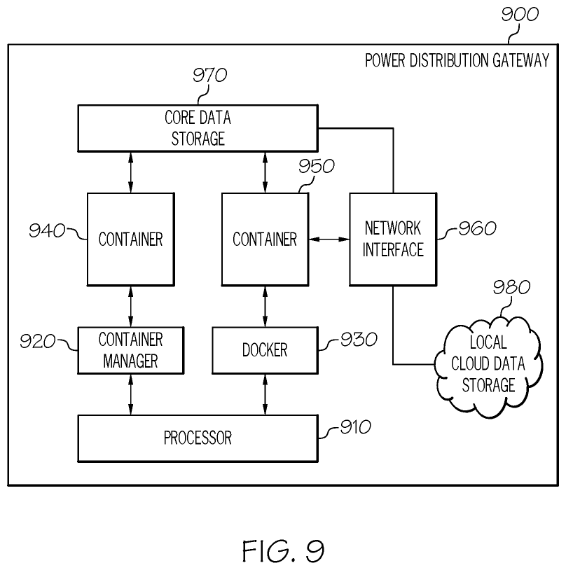

FIG. 9 is a block diagram of a power distribution gateway that may be included in the power distribution system of FIG. 2, according to various embodiments described herein. Referring to FIG. 9, a power distribution gateway 900, which may correspond to the power distribution gateways of FIGS. 2 to 6 and/or 8, includes various elements that include hardware, software, or combinations thereof. The power distribution gateway 900 includes a processor 910, container manager 920, docker 930, containers 940 and/or 950, core data storage 970, and/or network interface 960. The core data storage 970 may be part of the power distribution gateway 900. Network interface 960 may have interfaces that communicate with elements external to the power distribution gateway 900. The network interface may also facilitate communication to the cloud data storage 980.

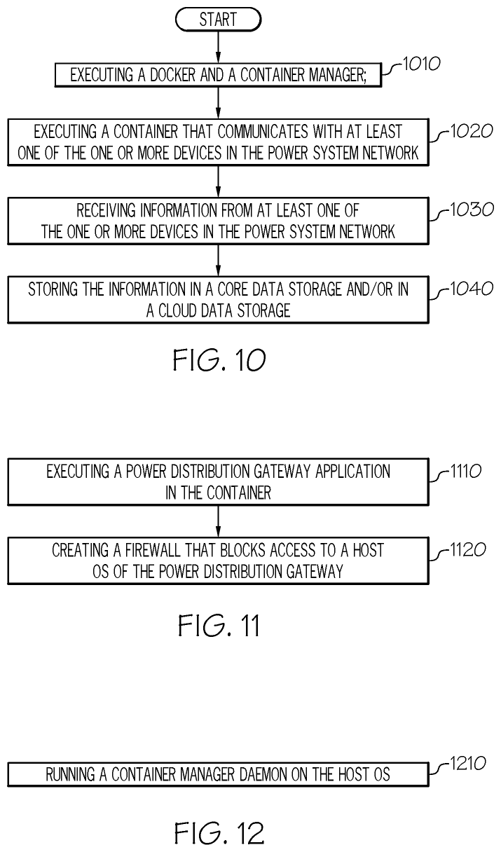

FIGS. 10 to 16 are flowcharts of operations of the power distribution gateway of FIGS. 2, 3 4, 5, 6, 8, and/or 9, according to various embodiments described herein. Referring to FIG. 10, operations of the power distribution gateway may include executing, on a processor of a host in the power distribution gateway, a docker and a container manager, at block 1010. Operations may include executing a container that communicates with the one or more devices 460 in the power system network, at block 1020. Operations may include receiving, through a network interface, information from the one or more devices 460 in the power system network, at block 1030. Operations may include storing the information in a core data storage in the power distribution gateway and/or in a cloud data storage that is remote from the power distribution gateway, at block 1040.

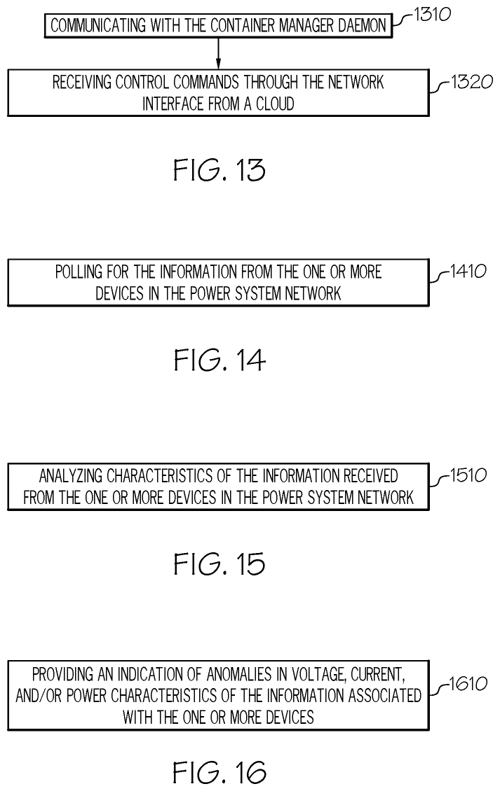

Referring to FIG. 11, operations of the power distribution gateway may include executing a power distribution gateway application in the container, at block 1110. Operations may include creating, by the container manager and the power distribution gateway application, a firewall that blocks access to a host OS of the power distribution gateway, at block 1120. Access from other containers than the container running the power distribution gateway application may be blocked for security purposes. Referring to FIG. 12, operations of the power distribution gateway may include running a container manager daemon on the host OS, at block 1210. The container manager daemon communicates with the power distribution gateway application of the container. Referring to FIG. 13, operations of the power distribution gateway may include communicating, by the power distribution gateway application, with the container manager daemon, at block 1310, and receiving control commands through the network interface from a cloud that is remote to the power distribution gateway, at block 1320.

Referring to FIG. 14, operations of the power distribution gateway may include polling, by the power distribution gateway, for the information from the one or more devices in the power system network, at block 1410. The information may include parameters related to operation of the one or more devices in the power system network. Referring to FIG. 15, operations of the power distribution gateway may include analyzing characteristics of the information received from the one or more devices in the power system network, at block 1510. Referring to FIG. 16, operations of the power distribution gateway may include providing an indication of anomalies in voltage, current, and/or power characteristics of the information associated with the one or more devices in the power system network, at block 1610.

Various embodiments presented herein have described a power distribution gateway that includes a docker architecture that provides isolation from the host. A docker and applications that run in containers on the processor provide a mechanism to receive, through a network interface, information from various devices in a power system network and storing this information in core data storage and/or in cloud data storage.

### Further Definitions

In the above-description of various embodiments of the present disclosure, it is to be understood that the terminology used herein is for the purpose of describing particular embodiments only and is not intended to be limiting of the invention. Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of this specification and the relevant art, and will not be interpreted in an idealized or overly formal sense unless expressly so defined herein.

When an element is referred to as being “connected”, “coupled”, “responsive”, or variants thereof to another element, it can be directly connected, coupled, or responsive to the other element or intervening elements may be present. In contrast, when an element is referred to as being “directly connected”, “directly coupled”, “directly responsive”, or variants thereof to another element, there are no intervening elements present. Like numbers refer to like elements throughout. Furthermore, “coupled”, “connected”, “responsive”, or variants thereof as used herein may include wirelessly coupled, connected, or responsive. As used herein, the singular forms “a”, “an” and “the” are intended to include the plural forms as well, unless the context clearly indicates otherwise. Well-known functions or constructions may not be described in detail for brevity and/or clarity. The term “and/or” includes any and all combinations of one or more of the associated listed items.

As used herein, the terms “comprise”, “comprising”, “comprises”, “include”, “including”, “includes”, “have”, “has”, “having”, or variants thereof are open-ended, and include one or more stated features, integers, elements, steps, components or functions but does not preclude the presence or addition of one or more other features, integers, elements, steps, components, functions or groups thereof.

Example embodiments are described herein with reference to block diagrams and/or flowchart illustrations of computer-implemented methods, apparatus (systems and/or devices) and/or computer program products. It is understood that a block of the block diagrams and/or flowchart illustrations, and combinations of blocks in the block diagrams and/or flowchart illustrations, can be implemented by computer program instructions that are performed by one or more computer circuits. These computer program instructions may be provided to a processor circuit of a general purpose computer circuit, special purpose computer circuit, and/or other programmable data processing circuit to produce a machine, such that the instructions, which execute via the processor of the computer and/or other programmable data processing apparatus, transform and control transistors, values stored in memory locations, and other hardware components within such circuitry to implement the functions/acts specified in the block diagrams and/or flowchart block or blocks, and thereby create means (functionality) and/or structure for implementing the functions/acts specified in the block diagrams and/or flowchart block(s).

These computer program instructions may also be stored in a tangible computer-readable medium that can direct a computer or other programmable data processing apparatus to function in a particular manner, such that the instructions stored in the computer-readable medium produce an article of manufacture including instructions which implement the functions/acts specified in the block diagrams and/or flowchart block or blocks.

A tangible, non-transitory computer-readable medium may include an electronic, magnetic, optical, electromagnetic, or semiconductor data storage system, apparatus, or device. More specific examples of the computer-readable medium would include the following: a portable computer diskette, a random access memory (RAM) circuit, a read-only memory (ROM) circuit, an erasable programmable read-only memory (EPROM or Flash memory) circuit, a portable compact disc read-only memory (CD-ROM), and a portable digital video disc read-only memory (DVD/BluRay).

The computer program instructions may also be loaded onto a computer and/or other programmable data processing apparatus to cause a series of operational steps to be performed on the computer and/or other programmable apparatus to produce a computer-implemented process such that the instructions which execute on the computer or other programmable apparatus provide steps for implementing the functions/acts specified in the block diagrams and/or flowchart block or blocks. Accordingly, embodiments of the present disclosure may be embodied in hardware and/or in software (including firmware, resident software, micro-code, etc.) that runs on a processor such as a digital signal processor, which may collectively be referred to as “circuitry,” “a module” or variants thereof.

The flowchart and block diagrams in the figures illustrate the architecture, functionality, and operation of possible implementations of systems, methods, and computer program products according to various aspects of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It should also be noted that in some alternate implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved. Moreover, the functionality of a given block of the flowcharts and/or block diagrams may be separated into multiple blocks and/or the functionality of two or more blocks of the flowcharts and/or block diagrams may be at least partially integrated. Finally, other blocks may be added/inserted between the blocks that are illustrated. Moreover, although some of the diagrams include arrows on communication paths to show a primary direction of communication, it is to be understood that communication may occur in the opposite direction to the depicted arrows.

Many different embodiments have been disclosed herein, in connection with the above description and the drawings. It will be understood that it would be unduly repetitious and obfuscating to literally describe and illustrate every combination and subcombination of these embodiments. Accordingly, the present specification, including the drawings, shall be construed to constitute a complete written description of various example combinations and subcombinations of embodiments and of the manner and process of making and using them, and shall support claims to any such combination or subcombination. Many variations and modifications can be made to the embodiments without substantially departing from the principles of the present invention. All such variations and modifications are intended to be included herein within the scope of the present invention.

1. A power distribution gateway that is configured to be coupled to one or more devices in a power system network, the power distribution gateway comprising:
a processor;
a docker and a container manager that are configured to execute by the processor independently of one another;
a first container associated with the container manager, wherein the first container is configured to execute on the processor and interfaces with the one or more devices in the power system network; and
a power distribution gateway application that executes in the first container,
wherein, when the power distribution gateway application is executed, the processor is configured to perform operations comprising:
receiving, through a network interface, information from the one or more devices in the power system network; and
storing the information in a core data storage in the power distribution gateway and/or in a cloud data storage that is remote from the power distribution gateway,
wherein the container manager and the power distribution gateway application block access from a second container associated with the docker to a host operating system (OS) of the power distribution gateway.

2. The power distribution gateway of claim 1,
wherein the container manager and the power distribution gateway application create a firewall to block access from the second container to the host OS of the power distribution gateway.

3. The power distribution gateway of claim 2, further comprising:
a container manager daemon that is configured to execute on the host OS,
wherein the container manager daemon is configured to communicate with the power distribution gateway application of the first container.

4. The power distribution gateway of claim 3, further comprising:
a module in the power distribution gateway application that is configured to communicate with the container manager daemon,
wherein the module is configured to receive control commands through the network interface from a cloud that is remote to the power distribution gateway.

5. The power distribution gateway of claim 4,
wherein the control commands that are received are executed in the first container or passed to the container manager daemon.

6. The power distribution gateway of claim 1,
wherein the power distribution gateway is configured to poll the one or more devices in the power system network for the information, and
wherein the information comprises parameters related to operation of the one or more devices in the power system network.

7. A power distribution gateway that is configured to be coupled to one or more devices in a power system network, the power distribution gateway comprising:
a processor;
a docker that is configured to execute on the processor and provide a software platform for the power distribution gateway; and
a container that is configured to execute on the processor and interface with the one or more devices in the power system network,
wherein, when the container is executed, the processor is configured to perform operations comprising:
receiving information from the one or more devices in the power system network;
storing the information in a core data storage in the power distribution gateway and/or in a cloud data storage that is remote from the power distribution gateway; and
controlling operations of the one or more devices based on the information from the one or more devices.

8. The power distribution gateway of claim 7, wherein the container comprises a gateway application container, the power distribution gateway further comprising:
an analytics container that comprises an Internet of things (IoT) circuit, an interface circuit, and an anomaly detection circuit.

9. The power distribution gateway of claim 8,
wherein the IoT circuit is configured to manage the one or more devices in the power system network.

10. The power distribution gateway of claim 8,
wherein the interface circuit is configured to communicate with the one or more devices in the power system network.

11. The power distribution gateway of claim 8,
wherein the anomaly detection circuit is configured to analyze characteristics of the information received from the one or more devices in the power system network.

12. The power distribution gateway of claim 11,
wherein the anomaly detection circuit is further configured to provide an indication of anomalies in voltage, current, and/or power characteristics associated with the one or more devices in the power system network.

13. The power distribution gateway of claim 7,
wherein the container is agnostic to changes in hardware of the power distribution gateway, and
wherein the hardware comprises the processor.

14. A method of operating a power distribution gateway that is coupled to one or more devices in a power system network, the method comprising:
executing, on a processor of a host in the power distribution gateway, a docker and a container manager;
executing, by the processor, a first container associated with the container manager that communicates with the one or more devices in the power system network;
receiving, through a network interface, information from the one or more devices in the power system network;
storing the information in a core data storage in the power distribution gateway and/or in a cloud data storage that is remote from the power distribution gateway; and
blocking access from a second container associated with the docker to a host operating system (OS) of the power distribution gateway.

15. The method of claim 14, wherein the blocking access from the second container to the host OS comprises:
executing a power distribution gateway application in the first container; and
creating, by the container manager and the power distribution gateway application, a firewall that blocks access to a host OS of the power distribution gateway.

16. The method of claim 15, further comprising:
executing a container manager daemon on the host OS; and
communicating with the power distribution gateway application, by the container manager daemon.

17. The method of claim 16, further comprising:
receiving control commands through the network interface from a cloud that is remote to the power distribution gateway.

18. The method of claim 14, further comprising:
polling, by the power distribution gateway, for the information from the one or more devices in the power system network,
wherein the information comprises parameters related to operation of the one or more devices in the power system network.

19. The method of claim 18, further comprising:
analyzing characteristics of the information received from the one or more devices in the power system network.

20. The method of claim 19, further comprising:
providing an indication of anomalies in voltage, current, and/or power characteristics of the information associated with the one or more devices in the power system network.
